(19) United States
(12) Patent Application Publication
(10) Pub. No.: US 2009/0203244 A1
(43) Pub. Date: Aug. 13, 2009

(54) Electrical Connector Abstract

(75) Inventors: Jacob M.J. Den Toonder, Helmond (NL); Jan M. Krans, Den Bosch (NL); Johannes T.A. Wilderbeek, Eindhoven (NL); Michel P.B. Van Bruggen, Helmond (NL); Peter J. Slikkerveer, Waalre (NL); Marinus J.J. Dona, Veldhoven (NL); Erik E. De Kluizenaar, Eindhoven (NL); David A. Eves, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,871

(22) PCT Filed: Apr. 15, 2005
(86) PCT No.: PCT/IB05/51234

§ 371 Date: Oct. 9, 2008

(30) Foreign Application Priority Data
Apr. 17, 2004 (GB) 0408607.0

(51) Int. Cl. H01R 13/28

(52) U.S. Cl. 439/285

(57) ABSTRACT

An electrical zipper-type connector is provided which can be used in wearable electronics applications. The connector has a first connector part (20) with an array of connector members (21, 24) and a second connector part (30) with an array of connector members (31, 34), which can mate with the first array of connector members. The first and second connector parts (20, 30) have contacts for forming a conductive path when the connector parts (20, 30) are mated with one another. Once the connector parts (20, 30) have been mated a force is applied between the contacts, which maintains them in electrical contact. The force can be applied in a variety of ways, such as by: a resilient coating (26) on the connector parts; a cord which pulls the connector parts together; having one connector part clasp the other connector part; or binding the connector parts together. Alternatively, the first connector part can comprise a set of teeth that provide mechanical alignment and interconnection and a flexible strap (615) that carries contacts.

This invention relates to electrical connectors and, in particular, to electrical connectors which are suitable for use in wearable electronics applications.

There is an increasing interest in integrating electronic apparatus into garments in an area which is generally known as ‘wearable electronics’. At the simplest level, the design of a garment can be modified to incorporate pockets for retaining electronic apparatus and cabling. At a more sophisticated level, electrical cabling is formed by weaving conductive fibres into a garment during the manufacture of the garment. The electronic apparatus which connects to the garment cabling may be fully washable. However, if the electronic apparatus is not fully washable, or if there is a need to allow the apparatus to be removed from time to time, it should be possible to easily connect and disconnect the apparatus. The types of connectors which are traditionally used in non-wearable situations are not always appropriate in the field of wearable electronics as the connector may be too bulky or lack sufficient flexibility. In many applications there is also a need to connect multiple lines as, for example, in the case of a display in which arrays of conductive lines must be connected to a driver in the correct way.

It has been proposed to use zipper-type connectors to make electrical connections in garments. One example is shown in GB 2,378,054.

It has been found that conventional zipper-type connectors can be unreliable when used in wearable electronics applications.

The present invention seeks to provide an improved connector which is suitable for use in wearable electronics applications.

Accordingly, a first aspect of the present invention provides an electrical connector comprising:

a first connector part having an array of connector members;

a second connector part having an array of connector members which can mate with the first array of connector members;

the first and second connector parts being rnovable into a mated position by a closing mechanism which is movable along the arrays;

respective parts of the first and second arrays of connector members having contacts for forming a conductive path when the connector parts are mated with one another; and

force applying means for continuously applying a force between the contacts after the connector parts have been mated.

Preferably, the electrical connector is a zipper-type connector. Conventional zippers, used in clothing, can generally be divided into two classes. In one class, sets of teeth have hooks and hollows that hook into one another by the wedging effect of a moving slider when the slider is operated. In another class, two spiral-shaped parts hook into one another when the slider is operated. However, the teeth/spirals are not in continuous mechanical contact with each other. While the loose mechanical contact allows individual teeth to have a limited relative movement, which adds to the flexibility of the zipper, this would immediately result in loss of electrical contact. The provision of the force applying means ensures mechanical, and hence electrical, contact at any time.

The electrical connector can be used in wearable electronics applications to connect cabling between electrical/electronic apparatus. The apparatus can be a portable device such as a media player, computer, wireless communications device or a component which requires connection to a portable device, such as a display, sensor, actuator, or any other kind of input or output device. One of the electrical connector parts can be connected to cabling which is either integrated with a textile article or sewn into it.

In some embodiments each of the arrays of connector members comprise teeth or other members which provide the features of aligning the connector parts and providing electrical connection, i.e. electrical connection is via the teeth of the zipper. In other embodiments the arrays of connector members comprise teeth or other members which serve to correctly align the two connector parts and additionally comprise a further part, such as a flexible strap, which carries contacts for providing the electrical connection.

Embodiments of the present invention will now be described, by way of example only, with reference to the accompanying drawings in which:

FIG. 1 shows a garment in which a zipper-type connector can be used;

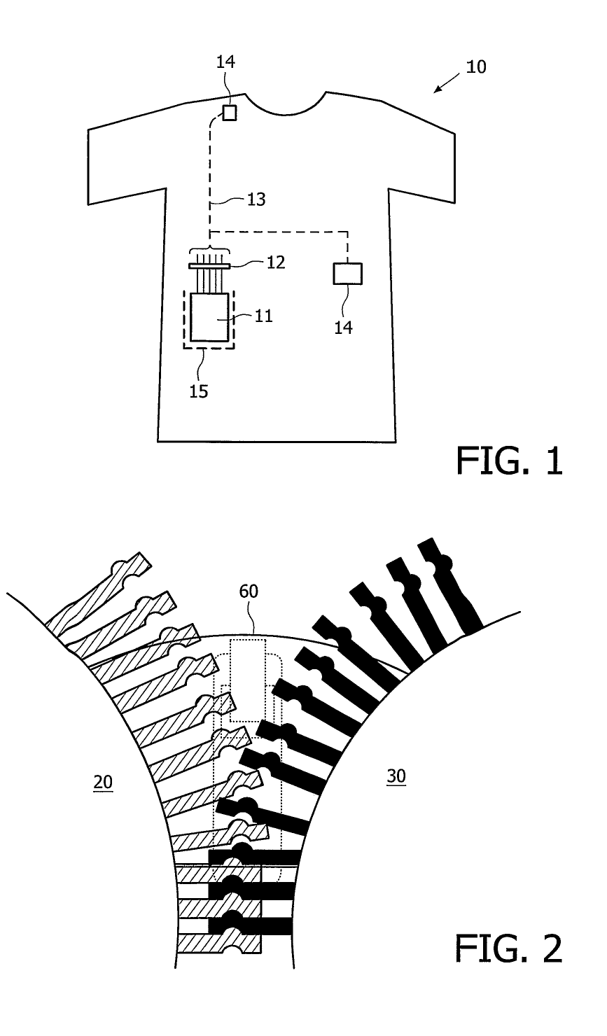

FIG. 2 shows the main parts of a zipper-type connector;

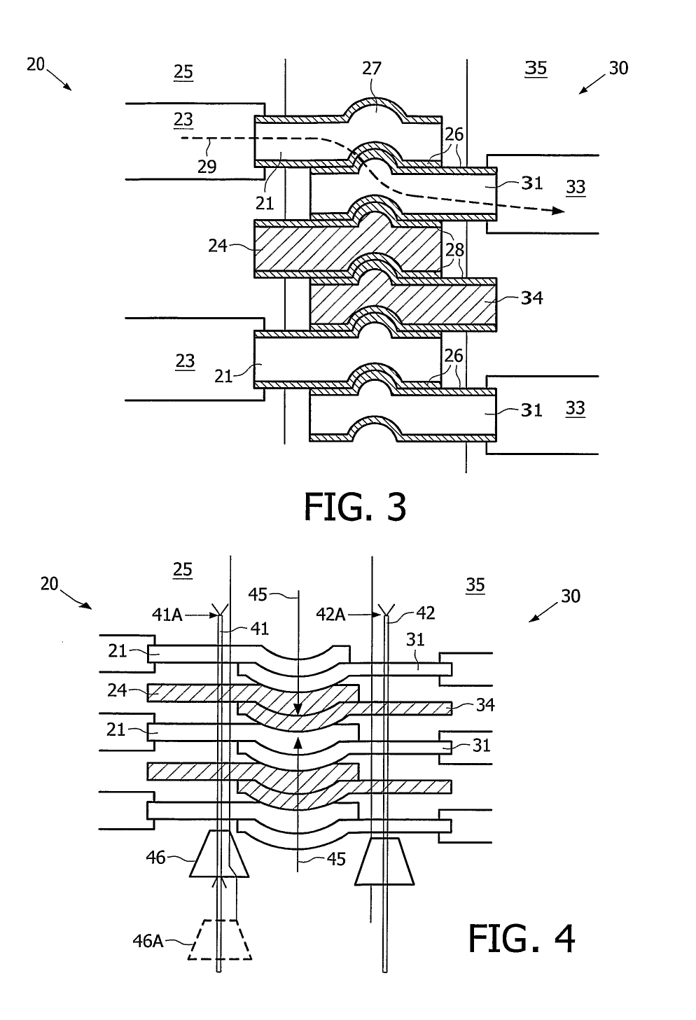

FIG. 3 shows an embodiment of a zipper connector with a resilient coating on the zipper teeth;

FIG. 4 shows a zipper connector in which a force can be applied in the direction of the longitudinal axis of the zipper;

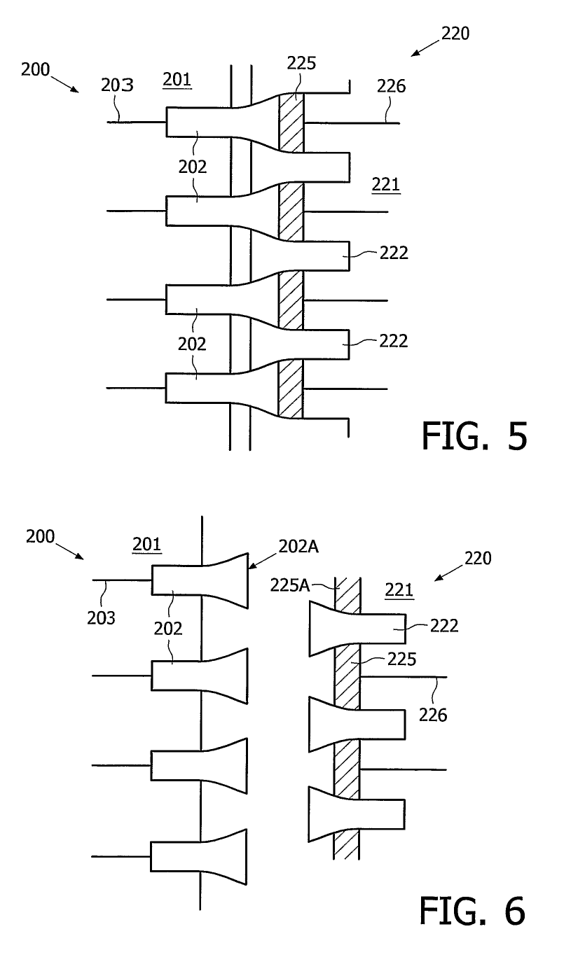

FIGS. 5 to 7 show a zipper connector in which contacts are mounted in a resilient material;

FIGS. 8 and 9 show an alternative to FIGS. 5 and 6 where a cord is fed along a channel within each connector part;

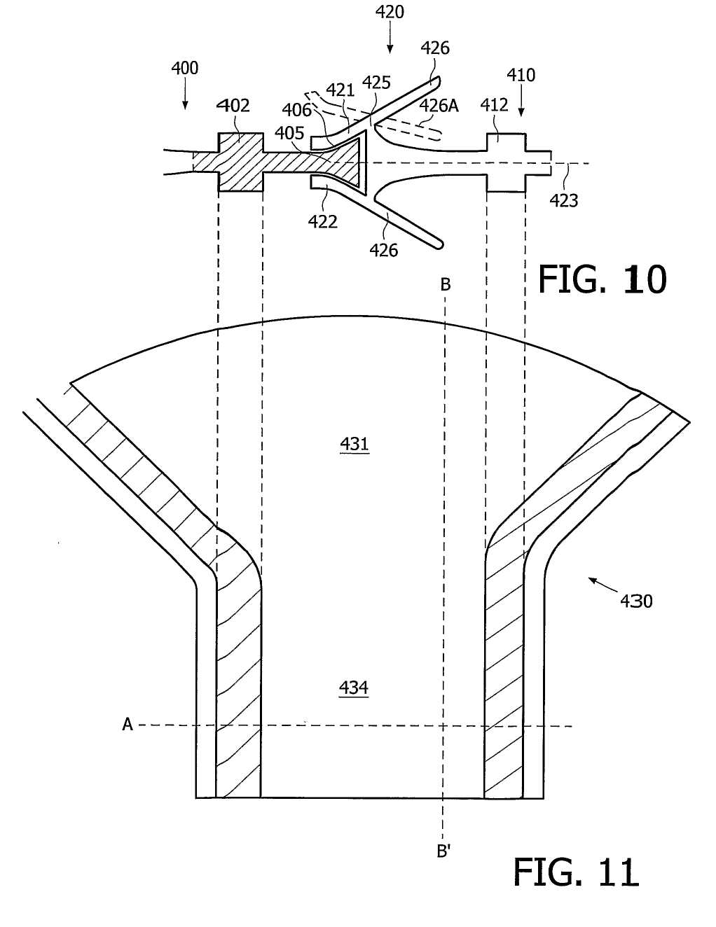

FIGS. 10 to 13 show a zipper connector with clamping parts;

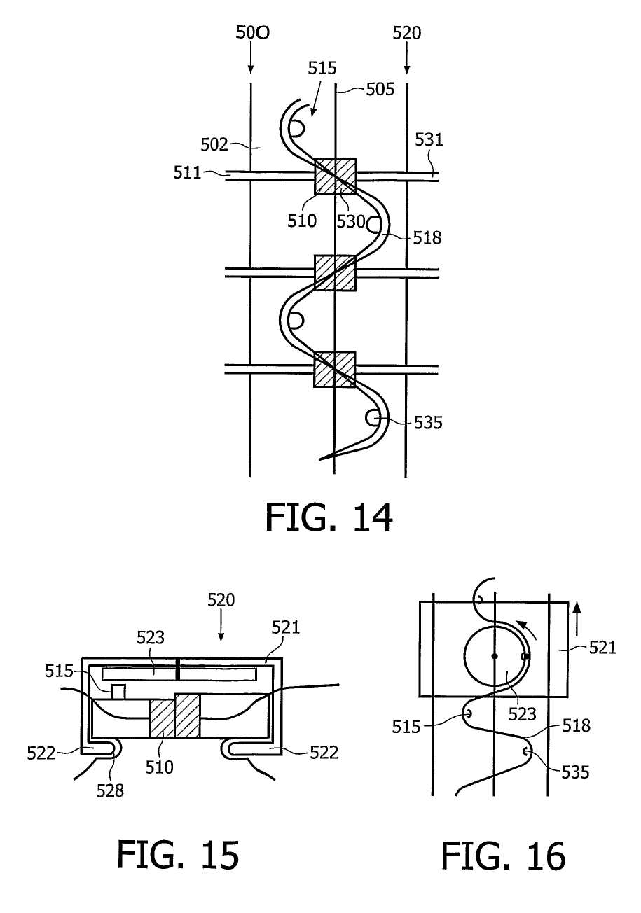

FIGS. 14 to 16 show a zipper-type connector in which connector parts are held together by a cord wound between the parts;

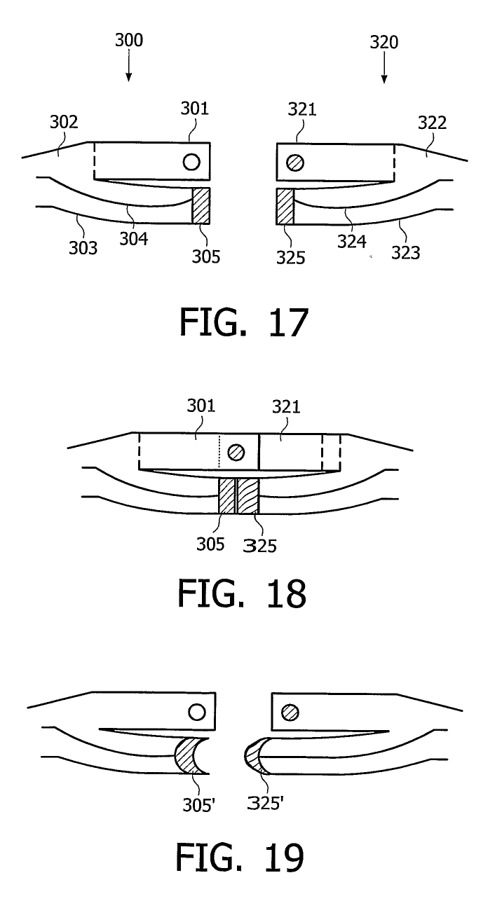

FIGS. 17 to 19 show a connector with two layers;

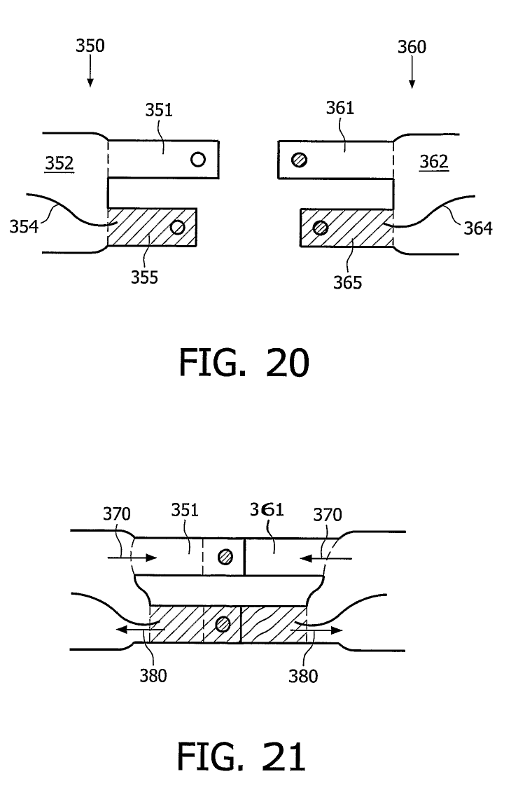

FIGS. 20 and 21 show a connector with two layers of interconnecting teeth;

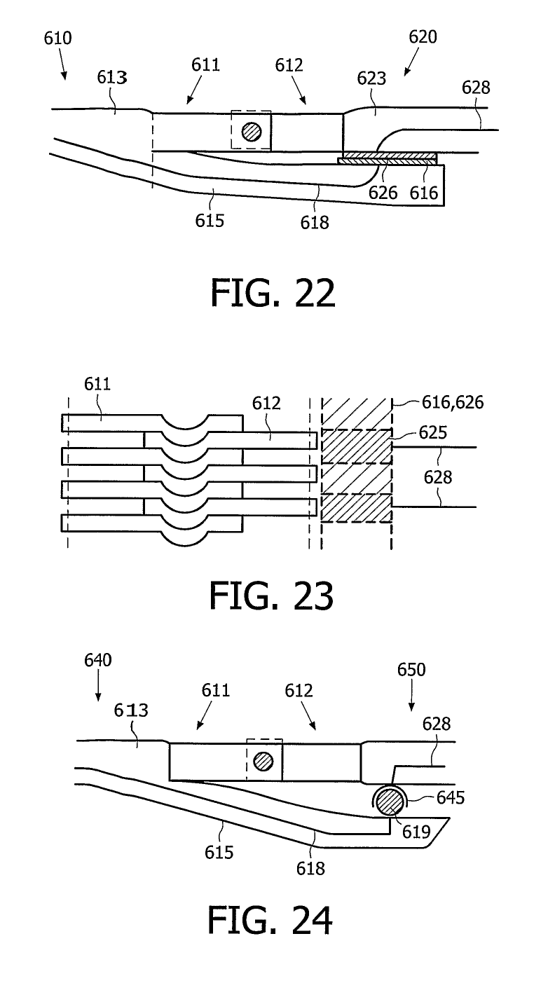

FIGS. 22 and 23 shows a zipper connector with an additional connecting strap which carries the electrical connection;

FIG. 24 shows an alternative zipper connector to that shown in FIGS. 22 and 23 with a different type of connector for the electrical connection.

FIG. 1 shows an example of a wearable electronics application in which the invention may be applied. A textile article 10, such as an item of clothing, includes electrical cabling 13 which interconnects various electrical or electronic apparatus 11, 14 within the article. Typically, cabling 13 is integrated into the structure of the article 10 such as by weaving conductive threads into the article during the manufacturing process of the article, although the cabling can be separate from the article 10 and secured in place by fabric loops etc. A zipper-type connector is generally shown at 12, connecting the internal cabling 13 with an electronic apparatus 11 which needs to be connected and disconnected on an occasional basis. Typically, electronic apparatus 11 is held within the article by a pocket 15.

FIG. 2 shows the zipper-type connector 12 of FIG. 1 in more detail. The zipper comprises a first connector part 20 and a second connector part 30, each connector part having a set of teeth which project outwardly from a strip of carrier material. The teeth can be interconnected with one another by sliding a fastener 60 along the connector parts. Similarly, the teeth can be separated by sliding the fastener 60 along the connector parts in the opposite direction. The fastener 60 can permanently form part of the connector or it may be removable from the connector parts after use to provide a structure which is generally flat.

FIG. 3 shows a first embodiment of a zipper-type connector having a first connector part 20 and a second connector part 30. The first connector part 20 comprises a set of teeth 21, 24 which project outwardly from a carrier strip 25. The carrier strip can be a flexible strip of material. The teeth are arranged on the carrier strip 25 so that they are alternately conducting teeth 21 and non-conducting (insulating) teeth 24. Each conducting tooth 21 is electrically connected to a conducting track 23. The second connector part 30 matches the first connector part 20 and has a set of conducting teeth 31 and non-conducting teeth 34 which project outwardly from a carrier strip 35. The corresponding sets of teeth on connector parts 20, 30 are aligned such that they can securely interlock with one another (as shown) when they are brought together by a zip fastener which slides along the connector parts 20, 30 in a conventional manner. Each tooth 21, 24, 31, 34 is elongate, with an arch-shaped profile in a central region 27. The arch-shaped region 27 serves to hold adjoining teeth together and prevents them from sliding apart. Each of the conducting teeth 21, 31 has an outer coating of a resilient conductive material such as a conducting elastomer or rubber. Once adjacent pairs of conducting teeth 21, 31 are brought together they remain securely in contact with one another by virtue of the force provided by the resilient coating 26. This force is sufficient to maintain good electrical connection between teeth 21, 31 even as the connector parts are subject to external forces. Dashed line 29 shows the path of an electrical signal from track 23 on connector part 20 to track 33 on connector part 30. Current flows from track 23, along conducting tooth 21, through the layers of resilient conducting material 26 on teeth 21, 31, along conducting tooth 31 and then along track 33. In FIG. 3 the non-conducting teeth 24, 34 also have an outer coating of a resilient material 28. It is preferred that this is a coating of resilient insulating material.

FIG. 4 shows another embodiment of a zipper-type connector. For simplicity, the same reference numerals are used to represent the same items as in FIG. 3. On each connector part 20, 30 there is a tensioning mechanism for applying a force in a direction which is aligned with the longitudinal axis of the array of zipper teeth. The tensioning mechanism comprises a thread or cord of material 41 on carrier strip 25 which extends from an anchoring point 41A on the carrier strip. The cord, in use, serves to apply a tensioning force 45 along the longitudinal axis of the array of teeth, i.e. in direction 45. There are several ways in which the tensioning mechanism can be operated.

In a first way, the tensioning mechanism is operated independently of the normal zipper. Once the zipper has brought the sets of teeth into the closed position (as shown) the tensioning mechanism is manually operated. The tensioning mechanism can be, for example, a manually operated mechanism 46 which grips the cord at whatever point the mechanism is positioned, and which is slidable along the cord by releasing a trigger or operating a catch. In use, and before the connector parts are brought together, the mechanism 46 is positioned at a lower end of the cord 41, as shown by position 46A. This releases tension on the teeth. The normal zipper mechanism (not shown) is then operated to bring the opposing sets of teeth together. Mechanism 46 is then moved from position 46A to the positioned shown in FIG. 4. This applies the tensioning force to the set of teeth. A corresponding tensioning mechanism is provided on the second connector part 30. The thread or cord can be a synthetic material such as Nylon. While a tensioning cord can be provided on only one of the connector parts 20, 30, it is preferred that a similar mechanism 42, 42A is provided on both of the connector parts 30.

In a second way, the tensioning mechanism is automatically operated by cooperation between the zipper slider mechanism (not shown) and the tensioning mechanism. The zipper slider mechanism can be attached to the cord so as to apply tension to the cord has the zipper slider is operated to bring the teeth into the closed position.

Although not shown in FIG. 4, a resilient conducting material can be applied to the outer surface of the conducting teeth 21, 31 to increase the tensioning force, in the same manner as previously described with respect to FIG. 3.

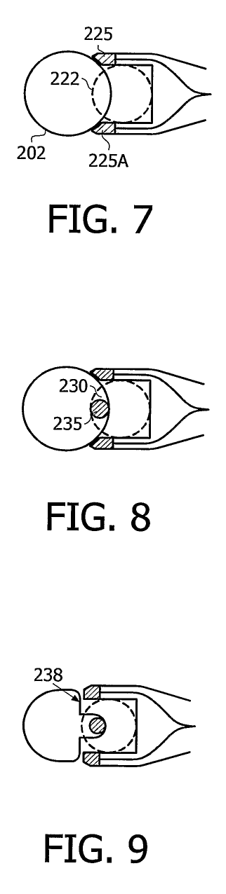

FIGS. 5-7 show a further embodiment of a zip connector. There are two connector parts 200, 220 which are shown in their disconnected position in FIG. 6. The teeth of the zipper are generally ring-shaped. A first set of conducting rings 202 project outwardly from a carrier strip 201 of the first connector part 200. A set of non-conducting (insulating) rings 222 are partially embedded in a resilient material 221 of the second connector part 220, with one end projecting outwardly from the material 221. Located between each non-conducting ring 222 is a pair of contact pads 225, which are best seen in the cross-sectional view of FIG. 7. The two sets of rings 202, 222 wedge-shaped in cross-section, which serves to hold the connector parts 200, 220 together in use. The end face 202A of each conducting ring 202 and the contact pads 225 are shaped such that they can press firmly against one another when the connector parts 200, 220 are brought together. In use, the two sets of rings 202, 222 are interlocked by a zip fastener (not shown) and the outer face 202A of each conducting ring 202 presses against a respective pair of contact pads 225. The resilience of material 221, on which the contact pads 225 are mounted, ensures that a reliable electrical connection is maintained between the conducting ring 202 and contact pads 225.

An alternative form of zip connector is shown in FIG. 8. The structure of the zip connector is similar to that shown in FIGS. 5-7. A first connector part has a set of conducting rings and a second connector part has a set of non-conducting (insulating) rings. However, the two sets of rings are held in an interlocked position by use of a thread or cord 235, which passes through each ring. The two sets of rings are dimensional such that when the set of conducting rings presses against the contact pads 225, there is only a narrow region of overlap 230 between the conducting rings and non-conducting rings which is sufficient to accommodate the cord 235. If the region of overlap 230 is too wide, then the cord 235 will not hold the conducting rings closely against the contact pads. Preferably, either the support material 221 for the non-conducting rings is a resilient material or the rings themselves are formed of a resilient material. The rings do not need to be wedge-shaped but can simply be flat rings. The cord can be pulled through the rings by the zip fastener. The shape of the rings can be varied from circular. In FIG. 9 the conducting rings have a stepped outer profile 238.

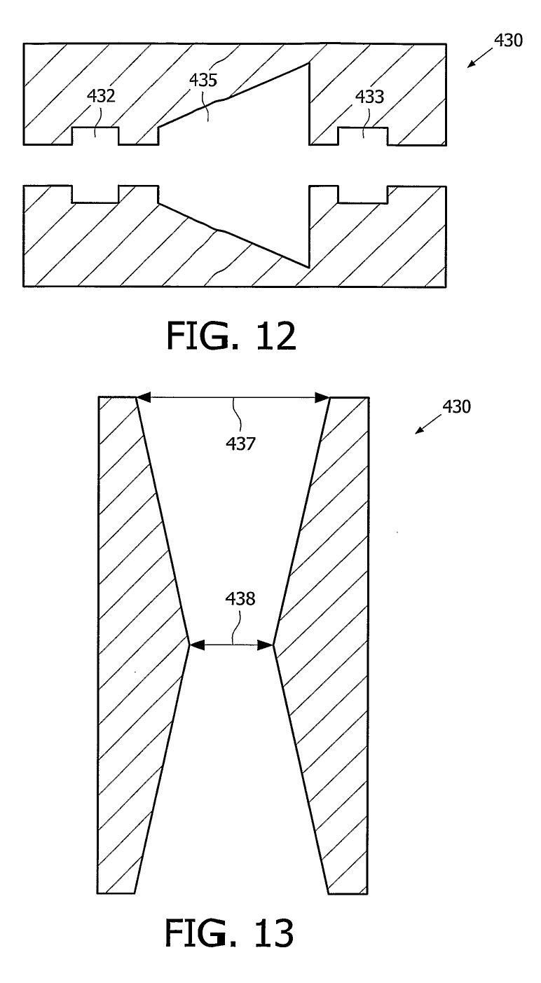

FIGS. 10-13 show a further connector arrangement. The conventional teeth of a zipper have been replaced by a set of clamping structures 420. A first connector part 400 has a rigid or semi-rigid structure with a generally cross-shaped profile. An end portion 405 of the structure has a wedge shape, with outwardly tapering sides 406. A second connector part 410 has a clamp-like structure 420 at one end. Clamp 420 has a pair of arms 426 mounted at an inclined angle, converging in the direction of the first connector part. Arms 426 are integrally formed with the remainder of the structure and, by virtue of being formed of a resilient material, are pivotable about a point 425. The distal ends of arms 426 form a pair of jaws 421, 422 which can grasp the wedge-shaped end portion 405 of first connector part 400. The arms are movable between a resting, grasping, position shown in FIG. 10 and the open position shown in dashed form 426A. A slider mechanism 430 is movable along the connector parts to connect and disconnect the connector parts. The slider 430 has a funnel-shaped entrance region 431, which serves to guide the first and second connector parts towards one another. FIG. 12 shows a cross-section along line A-A′ through portion 434 of the slider and FIG. 13 shows a cross-section along line B-B′ of the slider. Slider 430 has two channels 432, 433 which accommodate raised portions 402, 412 of the connector parts 400, 410. The raised portions 402, 412 act as rails which locate within channels 432, 433 on the slider 430 and the channels 432, 433 guide the connector parts 400, 410 through the slider 430. At either end of region 434 the slider 430 has a wide opening 437 that is sufficient to accommodate the clamp 420 in it's resting (clamped) state. Moving along line B-B′, region 434 of the slider narrows 438 mid-way along line B-B′.

Operation of the connector will now be described. It will be assumed that two sets of connector parts 400, 410 are initially separated and that slider 430 shown in FIG. 11 is moved upwards. Rails 402, 412 on connector parts 400, 410 initially locate in channels 432, 433 at the uppermost entrance to the slider 430. As slider 430 is moved upwards, the connector parts 400, 410 are guided towards one other. At the same time, arms 426 on connector part 410 are pressed gradually together, which opens jaws 421, 422. Movement of arms 426 is controlled by the narrowing walls of the slider (shown in the cross-section B-B′ of FIG. 13). This allows the connector part 400 to fit within the opened jaws of part 410. By the time that the connector parts 400, 410 reach the entrance to region 434 of slider 430 the connector parts 400, 410 are pushed fully against one another. As the connector parts 400, 410 move downwards through region 434 of the slider 430 the arms 426 of clamp are gradually allowed to move apart to their resting position, which causes jaws 421, 422 to grasp end portion 405 of connector part 400. Movement of the arms 426 is controlled by the widening walls of the slider. By the time that the connector parts 400, 410 emerge from the bottom of slider 430, they are fully mated, with jaws 421, 422 firmly grasping end portion 405.

Although the clamp structure 420 is shown with arms 426 integrally formed with the remainder of the second connector part, they could be separately formed, pivotally mounted to the remainder of the connector part and biased into the position shown in FIG. 10 by a resilient member such as a spring.

FIGS. 14-16 show a connector having a first connector part 500 and a second connector part 520 of the same structure. Each connector part 500, 520 has a flat face 505, which forms a line of contact with the other connector part 500, 520. Each connector part 500, 520 has a set of electrical contact pads 510, 530 which are spaced along the connector part. Contact pads on the first and second connector parts 500, 520 are aligned with one another. Insulating material separates the contact pads 510, 530 from one another. A conducting track or lead 511, 531 joins to each contact pad 510, 530. Posts or hooks 515, 535 extend upwardly from each of the connector parts, perpendicularly to the plane of the connector part. The position of posts 515, 535 is staggered, with posts being alternately positioned on the first and the second connector part in the direction of the longitudinal axis. The connector parts are held against one another by weaving a thread or cord 518 around the posts 515, 535. The thread 518 can be dispensed by a slider mechanism 520 of the kind shown in FIGS. 15 and 16. The slider mechanism 520 comprises a generally ‘C’ shaped plate 521 which fits over the connector parts, with arms 522 which fit in a channel 528 beneath each connector part. A wheel 523 is mounted on the plate 521 which can rotate as the slider is moved along the array. The leading end of the thread 518 is attached to a point on the periphery of the wheel 523. As the slider 520 is moved along the array, the thread 518 is laid out in a sinusoidal path around the outside of each of the posts 515, 535. By ensuring that the thread 518 is sufficiently tight, the two connector parts 500, 520 are pulled firmly against one another, which results in a good electrical connection between the contacts 510, 530, even as the connector is flexed.

As an alternative to feeding the thread 518 around each of the posts 515, 535, the thread 518 can be threaded through an eye on each post 515, 535. As a further improvement, the connector part can be formed at least in part of a resilient material, which further helps to maintain a reliable electrical connection between the contact pads 510, 530.

FIGS. 17-18 show a connector with two layers. A first connector part 300 has a set of teeth 301 projecting from a carrier strip 302. Similarly, a second connector part 320 has a set of teeth 321 projecting from a carrier strip 322. Teeth 301, 321 can be conventional zipper teeth, with locking being achieved by a wedged shape or by interlocking dents and “hillocks”. Each connector part 300, 320 has a second layer of resilient material 303, 323 which carries an electrical contact 305, 325 at the distal end. A lead or track 304, 324 connects to the contacts 305, 325. A conventional zipper slider (not shown) slides along the connector parts and interlocks the zip teeth 301, 321, bringing them into the position shown in FIG. 18. As the zip teeth are brought together, the contact pads 305, 325 are also pushed together. The contact pads securely remain in contact with one another by virtue of the resilient material 303, 323. The zipper teeth 301, 321 ensure that the contact pads are correctly aligned, but they do not electrically conduct. It should be noted that the teeth 301, 321 overlap with one another when they are mated. This forces contact pads 305, 325 to be pushed against one another.

The precise form of the zipper used in the upper layer can vary from the one shown here, e.g. it can be a spiral-like zipper. The contact pads 305, 325 can have flat end faces, as shown in FIGS. 17 and 18 or curved faces. In FIG. 19 one of the connector parts has a concave shaped face while the other connector part has a convex shaped face. This helps to prevent the contact pads from sliding sideways (up or down in FIG. 18) as they are pushed together.

FIGS. 20 and 21 show another connector with two layers. This embodiment has two layers of zip connectors. A first connector part 350 has a first set of teeth 351 projecting from a carrier strip 352. Similarly, a second connector part 360 has a first set of teeth 361 projecting from a carrier strip 362. Each connector part 350, 360 also has a second layer of teeth 355, 365 mounted beneath the first layer. Some of the teeth in the second layer are conducting teeth, with a connecting lead or track 354, 364. When viewed from above, alternate teeth in the second layer can be conducting teeth, with non-conducting (insulating) teeth placed between them. The teeth in the second layer are shorter than those in the first layer. The carrier strip 352, 362 is formed of a resilient material. A double-layered slider (not shown) slides along the connector parts and interlocks the zip teeth of both layers, bringing them into the position shown in FIG. 21. The zip teeth 351, 361 in the upper layer are subject to an inwardly directed compressive force 370 while the teeth in the lower layer are under tension 380. The balance of forces causes the conducting teeth 355, 365 in the second layer to securely remain in contact with one another. The difference in length between the teeth in the two layers causes a ‘closing’ force, which is oriented in opposite directions in the two layers. The specific geometry of the teeth ensures that the teeth are not simply pulled apart.

FIGS. 22-23 show a further connector arrangement. A first connector part 610 comprises a first set of zip teeth 611 which projects outwardly from a carrier strip 613 and a flexible connecting strap 615. The connecting strap 615 can be formed of the same material as the carrier strip 613 and can simply be an extension of it. A second connector part 620 comprises a second set of zip teeth 612 which projecting outwardly from a carrier strip 623. The strap 615 is sufficiently long that it can overlie the carrier material 623. The free end of the strap 615 carries a strip of fastening material such as Velcro™ and the carrier strip 623 of the second connector part 620 carries a complementary strip of fastening material at a position which matches the position of the fastening material 616 on the strap 615. Electrically conducting contact pads 625 are formed in the fastening material 616 of the strap 615 and the fastening material 626 of the second connector part 620. The contact pads 625 on the fastening material 616, 626 are aligned with one another such that when the zip teeth 611, 612 are aligned with one another, the contact pads are also aligned with one another. The contact pads 625 can be formed as pads of conducting material, such as metal or a conducting fabric or other flexible material, which are embedded within the fastening material. Alternatively, the components of the fastening material itself can be modified to be electrically conduct in certain regions. In the case of Velcro™, the components are miniature hooks and coarse fibres. A conducting track or lead 618, 628 connects to each contact pad 625. The precise form of the zipper can vary from the one shown here, e.g. it can be a spiral-like zipper. In this embodiment the zipper teeth 611, 612 provide mechanical interlocking and alignment but do not provide electrical connection. Electrical connection is provided by the strap 615.

FIG. 24 shows an alternative form of connector arrangement which has many similarities with the connector arrangement just described. A zipper type connector having teeth 611, 612 provides mechanical interlocking while electrical connection is provided by a flexible strap 615. Flexible strap 615 extends from a first connector part 640 and carries a plug part 619. The second connector part 650 has a clamping strip 645 which can securely clamp the plug part 619. In this way, a reliable electrical connection is obtained. A particularly suitable type of clamping strip is a bistable one, which is operable between an open position, in which the plug part can be freely pushed between the jaws of the strip, and a locked position in which the jaws of the clamping strip firmly grasp the plug part. The plug part can be an individual conducting piece or it can extend continuously along the connector, in which case it has conducting regions positioned along it, separated by insulating regions. As before, the precise form of the zipper can vary from the one shown here and can be, for example, a spiral-like zipper.

In each of the above embodiments, it will be appreciated that the connector can be post-treated in some way after the first and second connector parts have been mated. The treating can include one or more of pressing, heating, or exposure to ultra-violet (UV).

In each of the described embodiments any single contact pad can include a plurality of individual sub-connections, i.e. each contact pad can be sub-divided into multiple contact pads which each provide a separate conductive path. This increases the connection density.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in the claim.

1. An electrical connector comprising:
a first connector part (20) having an array of connector members (21, 24);
a second connector part (30) having an array of connector members (31, 34) which can mate with the first array of connector members;
the first and second connector parts (20, 30) being movable into a mated position by a closing mechanism which is movable along the arrays;
respective parts of the first and second arrays of connector members having contacts for forming a conductive path when the connector parts are mated with one another; and
force applying means for continuously applying a force between the contacts after the connector parts (20, 30) have been mated.

2. An electrical connector according to claim 1 wherein the force is directed along the longitudinal axis of the arrays of connector members.

3. An electrical connector according to claim 2 wherein the force applying means is arranged to pull the connector members together in a direction which is aligned with the longitudinal axis of the arrays of connector members.

4. An electrical connector according to claim 3 wherein the force applying means is a cord (41) which extends between one end of the array (41A) and a point at least beyond the other end of the array.

5. An electrical connector according to claim 2 wherein the force applying means is manually operable.

6. An electrical connector according to claim 2 wherein the force applying means is operable by cooperation between the closing mechanism and the cord.

7. An electrical connector according to claim 1 wherein at least some of the connector members have a resilient outer coating (26).

8. An electrical connector according to claim 1 wherein the connector members in the second array are arranged to clasp (420) the connector members in the first array.

9. An electrical connector according to claim 8 wherein the connector members in the second array act in a direction which is substantially normal to the longitudinal axis of the arrays of connector members.

10. An electrical connector according to claim 9 wherein the connector members in the second array comprise jaws (421, 422) which are movable in a direction substantially normal to the longitudinal axis of the arrays of connector members.

11. An electrical connector according to claim 10 wherein the jaws (421, 422) are biased into a clasping position and are movable into an open position as the closing mechanism (430) is moved across the jaws.

12. An electrical connector according to claim 8 wherein the connector members in the second array comprise electrical contacts (225) which are held in a resilient mounting (226).

13. An electrical connector according to claim 1 wherein the force is applied between the first and second arrays of connector members, perpendicularly to the longitudinal axis of the arrays, and in the plane of the arrays.

14. An electrical connector according to claim 13 wherein each array of connector members comprises a first layer which comprises connector members (301, 321) which provide mechanical interconnection and alignment and a second layer which comprises electrical contacts (305, 325).

15. An electrical connector according to claim 14 wherein the second layer comprises a further set of connector members which provide mechanical interconnection and alignment (355, 365).

16. An electrical connector according to claim 14 wherein the second layer is resiliently mounted such that a compression force is applied between the contacts.

17. An electrical connector according to claim 13 wherein the first and second connector parts comprise posts (515, 535) and the closing mechanism (520) is arranged to wind a cord (518) around posts of both connector parts whereby to pull the connector parts towards one another.

18. An electrical connector according to claim 13 wherein each of the connector parts comprises a channel which extends along the part and the closing mechanism is arranged to feed a cord (235) along the channel.

19. An electrical connector according to claim 1 wherein the first array of connector members comprises a set of connector members which provide mechanical interconnection and alignment and a flexible strap (615) which carries contacts for forming a conductive path with contacts on the second connector part.

20. An electrical connector according to claim 1 in the form of a zipper-type connector.

21. A textile article comprising an electrical connector according to claim 1.

22. An electronic apparatus comprising an electrical connector according to claim 1.
